(19) United States
(12) Patent Application Publication
(10) Pub. No.: US 2009/0129293 A1
(43) Pub. Date: May 21, 2009

(54) RECORDING A CIRCUIT SWITCHED CALL USING AN IP BASED CONTROL INTERFACE

(76) Inventors: Jos den Hartog, Capelle a/d ljssel (NL); Rogier Noldus, Goirle (NL)

Correspondence Address: ERICSSON INC., 6300 LEGACY DRIVE, M/S EVR 1-C-11, PLANO, TX, 75024, US

(21) Appl. No.: 12/093,208

(22) PCT Filed: Nov. 17, 2005
(86) PCT No.: PCT/EP2005/012409

§ 371 Date: Sep. 26, 2008

(51) Int. Cl. H04L 12/16

(52) U.S. Cl. 370/259

(57) ABSTRACT

A method of recording at least a part of a conversation between a plurality of conversation parties, wherein said conversation is enabled by establishing a call through a circuit switched telecommunications network. Said at least one part of said conversation is recorded in a data file using a recording system which is located in the network at a central location, and said recording is controlled by control signals provided to said recording system through a packet switched telecommunications network by at least one of said conversation parties. Said control signals identify said call for associating said control signals with said conversation. By providing the control through the packet network no DTMF tones need to interrupt the ongoing conversation to start and stop recording using access codes which also means that no monitoring circuit need continually be inserted in the voice path. Thus control of the recording is provided using an IP based interface rather than via the circuit switched path.

### FIELD OF THE INVENTION

The present invention relates to a method of recording at least a part of a conversation between the plurality of conversation parties, wherein said conversation is enabled by establishing a call through a circuit-switched telecommunications network using a telecommunications service provided by a telecommunications provider, wherein at least one part of said conversation is recorded in a data file using a recording system which is maintained by said telecommunications provider.

The present invention further relates to a recording system for use in a method as described above, for recording at least a part of a conversation between the plurality of conversation parties, wherein said conversation is enabled by establishing calls through a circuit-switched communication network using a telecommunication service provided by telecommunications provider.

In addition, the present invention relates to an arrangement for use in a method as described above and comprising a recording system as described above.

Within the telecommunications industry it is known to provide the service which enables customers of telecommunication services such as voice services provided through a telecommunications network to record at least a part of a call in order to be able to refer to said recording at a later stage. Such services are particularly handy to customers for a variety of reasons, including the recording of any information exchanged during the call such as spoken address information, an agreed appointment or a time schedule for having a meeting, an agreement being affected over the phone or a decision which is made by parties contributing to the conversation.

In a later stage, for example when a written confirmation of the decision, or appointment (etc.) has to be provided, or in the case that any of the parties forgot about the agreements or decisions made, such a recording provides the ability to refer back to the conversation and established exactly what has been said by whom.

Conversations such as voice calls or video conferences, are often facilitated using circuit-switched telecommunications networks. In a circuit-switched telecommunications network, a call is set up through the telecommunications network using one or more network elements. Upon establishing of the call, a remote conversation party answers the call, e.g. by picking up a telephone hook, establishing a “virtual circuit” through the telecommunications network. Such a virtual circuit is a temporarily available communications channel via an established path through the circuit-switched telecommunications network. The conversation takes place by exchanging communication signals over said communication channel.

Existing recording services may for instance make use of a recording system somewhere connected in a network, which is arranged for intercepting or receiving the communication signals exchanged during the call and for recording these signals using suitable recording means. Such a recording system may for example be connected to a switch in the telecommunication network. And the service itself may be provided using a service control point (SCP) controlling the interception of the communication signals and the forwarding thereof to the recording system. During a telephone call, one of the conversation parties may initiate the recording of the conversation e.g. by pressing a button on the telephone, causing the sending of dual tone multifrequency signals (DTMF) that are recognized in the service switching point, and forwarded to the service control point. Upon receipt of the DTMF signals, a voice controlled menu may be provided to the conversation parties explaining the options of the recording and the procedure for initiating it.

A disadvantage of recording methods as described above, is that in order to recognize the initiation of the recording service, in particular in order to receive the DTMF signals during the call, the call must be permanently monitored by a network element such as the service control point. Where no such service will be provided during the telephone call, after establishing the call the telecommunication network may remain passive with respect to the call until the call is terminated by any of the parties involved. Providing the recording service as described above therefore puts an extra demand on the amount of network resources used by the call. Where the recording service is a standard service provided by the telecommunications provider, enabling all customers establishing calls through the circuit-switched telecommunications network with the recording service as described, significantly increases the required network resources since all calls that are simultaneously ongoing over the circuit-switched telecommunications network must be monitored for providing the service.

Another disadvantage of the service described above is that the conversation must be interrupted by the parties in order to initiate the service. Not only is it required for the conversation parties to send a DTMF signal during the call, but the procedure following the initiation of the recording service provides a further interruption of the conversation. This may be interpreted by any of the conversation parties as annoying and detrimental to the ongoing conversation. It is especially noted here that when a DTMF signal is sent during the call, none of the conversation parties is able to hear any of the other conversations parties speaking, and it will be understood that this may also be the case during the voice controls procedure after initiating a recording.

Another problem of prior art recordings services, is that the sending of DTMF signals is prone to errors and disturbances. While a DTMF signal is sent, it may be interfered by inferior line quality, or loud noises sent during the call at the same time. On the other hand, when a DTFM tone is sent during a voice conversation, it can be heard rather loudly by the other conversation parties, and again maybe interpreted as an annoying disturbance of the conversation.

A further disadvantage of recording methods and recording services provided using prior art methods is that a plain recording of a part of a conversation on a recording system does not guarantee to any of the parties at a later stage, that the recorded conversation is not tampered with. It is unknown to the conversation parties whether the recording system or the depository system wherein the recording recites, is owned or managed by a trusted party.

### SUMMARY OF THE INVENTION

It is an object of the present invention to provide a method of recording at least a part of a conversation between the plurality of conversation parties, a recording system and an arrangement for performing this method, which resolves the above-mentioned disadvantages, enabling a secure and trusted recording of at least a part of a conversation ongoing over a circuit-switched telecommunications network.

The above-mentioned and other objects of the invention are achieved in that there is provided a method of recording at least a part of a conversation between a plurality of conversation parties, wherein said conversation is enabled by establishing a call through a circuit switched telecommunications network using a telecommunication service provided by a telecommunications provider, wherein said at least one part of said conversation is recorded in a data file using a recording system which is maintained by said telecommunications provider, and wherein said recording is controlled by control signals provided to said recording system through a packet switched telecommunications network by at least one of said conversation parties, wherein said control signals identify said call for associating said control signals with said conversation.

By making a recording of at least a part of a conversation in a data file, the recording may be easily stored in a database and made available to at least one of the conversation parties at a later stage. Also, the use of a data file enables the application of a large range of safety methods in the form of encryption, authentication, and the like to be performed on the data file. This will be described below with reference to specific embodiments of the invention. Since the control signals for initiating and controlling the service are provided through a packet switched network, the ongoing monitoring of the call in the circuit switched telecommunications network is not necessary. Simply at the moment that an instruction is provided by any of the conversation part to initiate the recording of the conversation, the call is intercepted or received by the recording system and is recorded as described above in the data file. In addition, since the instructions for initiating the recording are provided through the packet switched telecommunications network, there is no need to interrupt the ongoing conversation and therefore the initiation of the recording service is not experienced as an interruption of the call.

Also since the recording system is maintained by the telecommunications provider, the recording system itself is maintained by a trusted source, and after the recording has been made, the recording cannot be tampered with by any of the conversation party or any third party. This will in particular be beneficial in cases where the recording is to be used as any kind of legal evidence of the conversation taking place.

In order to be able to associate the control signals provided through the packet switched telecommunications network with the ongoing call in the circuit switched telecommunications network, the ongoing call is identified by the control signals. This may be performed in a plurality of different ways, some of which will be described here and below.

According to an embodiment of the present invention, at least one of the conversation parties uses means for connecting to that circuit switched telecommunications network and means for connecting to said telecommunications network. Using both said means, said conversation party is able to provide the recording system with control signals through the packet switched telecommunications network while performing the call using the circuit switched telecommunications network. The means for connecting to the circuit switched telecommunications network may for instance comprise the regular circuit switched telecommunications terminals such as an ordinary phone, a mobile phone or the like. Means for connecting to the packet switched telecommunications network may comprise any suitable means such as a personal computer, a personal digital assistant (PDA), a mobile phone suitable for connection to for example the Internet (using for example general packet radio service (GPRS) or universal mobile telecommunication services (UMTS)).

In accordance with a specific embodiment of the invention, the means for connecting to the circuit switched telecommunications network and the means for connecting to the packet switched telecommunications network are integrated in a single communications terminal matched or accessible by the conversation party making the call. Such a communications terminal therefore provides a hybrid system enabling the connection to both the circuit switched telecommunications network and the packet switched telecommunications network and enabling the use of hybrid telecommunications services that used both circuit switched telecommunications network resources and packet switched telecommunications network resources.

In accordance with another embodiment of the present invention, the control signals are provided as signalling messages associated with said call, and the call is identified by said signalling messages. Since the signalling messages are used by the telecommunications network for controlling parameters of the call, there is a relation between the signalling messages and the call, which may be used for identifying the call. By sending the control signals as signalling messages associated with the call, the control signals identify the call by said signalling messages, thereby associating the control signals with the conversation.

In accordance another embodiment of the invention, the control signals comprise call identification data for identifying that call. Said call identification may comprise for example a network call reference number such as global call reference number which is widely used in telecommunications networks for identifying calls, party identification data for identifying at least one of the conversation parties, such as an A number or B number of a calling or called party, or call detail identification data and for identifying for instance a call detail record associated with the call. By identifying a relevant call detail record (CDR) for a call, all details of the call are known.

The method of the present invention may be triggered when the control signals comprises a request signal sent by any of the conversation parties for commencement of the recording. After receiving of an approval signal sent by the other conversation party, the recording system may initiate a recording. The recording itself is stored in the data file, which in accordance with an embodiment, is encrypted using an encryption code. By encrypting the data file, authorized access to the recording may be effectively avoided.

The data file may me made available to at least one of the conversation parties or to all of them. In order to enable unlimited access to the recording at all time by any of the conversation parties, the data file may be stored in a database, which database is operatively connected to said packet switched telecommunications network. Note that where the database is maintained or managed by the telecommunications provider, it may be guaranteed that the recording is under the power of a trusted party, such that tampering with the recording by any of the parties is not possible. The database may be accessible by any of the conversation parties. As an alternative, the recording system may provide copies of the data file to one or more of the conversation parties, preferably to all conversation parties. It will be understood that the data file itself may in addition also be stored in the database as described above, for later reference.

An other advantage of the present invention is that the data in the data file may not be limited to a digital representation of the recording. Since the recording is stored in a digital file, additional data may be added to the file. This additional data may for instance include an authentication code for certifying the authenticity of the file.

Such an authentication code may for example be based on the contents of the data file, such that when the recording is tampered with, the authentication code does not comply with the contents of the file, and tampering is detected. The format of such authentication code is known to the person skilled in the art.

The additional data included in the data file may also comprise service data such as call data (in particular call details from e.g. the call detail record), a reference to call detail record in a service database comprising call data, commencement time of the recording, termination time of the recording, duration of the recording, party identification data for identifying at least one of the plurality of conversation parties, etc.

Instead of, or in addition to, the additional data described above, the data file may comprise a user file or a part of a data stream exchanged between the conversation parties through the packet switched telecommunications network. It will be appreciated that in case use is made of a combinational service using both circuit switched telecommunications network and a packet switched telecommunications network, each conversation party has the possibility to provide the other conversation part with for instance a user file such as presentation, a text file, a picture, or any other file of interest. Such a user file may be sent to the packet switched network, and may be included in the data file of the recording. The recording in that case contains more than just a representation of what has been said by the conversation parties, and takes into account all information exchanged during the recorded part of the conversation. It will be understood that the method of the present invention may be applied to voice communication calls over a circuit switched telecommunications network, or alternatively to for example a video conference or the like.

In accordance with the second aspect of the present invention there is provided a recording system for use in a method as described above, for recording at least a part of a conversation between a plurality of conversation parties, wherein said conversation is enabled by establishing a call through a circuit switched telecommunications network using a telecommunication service provided by a telecommunications provider, said recording system comprising means for receiving control signals from a packet switched telecommunications network, and means for operatively connecting to said circuit switched telecommunications network for recording said at least one part of said conversation, and means for creating a data file comprising recording data indicative of said at least one part of said conversation, wherein said recording system further comprises means for identifying said call by said control signals for associating said control signals with said conversation.

In accordance with a third aspect of the present invention there is provided an arrangement, comprising a circuit switched telecommunications network for enabling conversation between a plurality of conversation parties, a recording system as described above, and a packet switched telecommunications network for remotely providing control signals to the recording system for controlling the recording, said arrangement further including means for identifying said call by said control signals for associating said control signals with said conversation.

The above-mentioned and other features and advantages of the invention are illustrated in the following description of preferred embodiments thereof, with reference to the enclosed drawings.

### BRIEF DESCRIPTION OF THE DRAWINGS

FIG. 1 discloses an arrangement according to the invention, wherein a method of the present invention and/or a recording system of the present invention may be implemented.

### DETAILED DESCRIPTION OF THE DRAWINGS

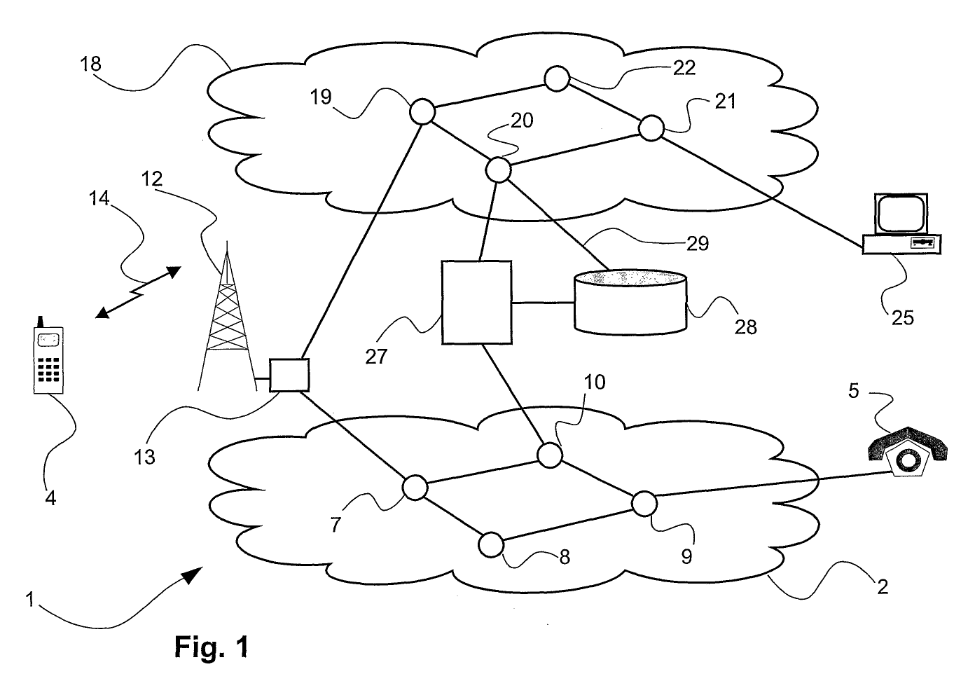

In FIG. 1 the arrangement 1 is shown comprised of a circuit switched telecommunications network 2 enabling the establishment of e.g. a voice or video call between a first mobile terminal unit 4 of a first user and a second terminal unit 5 of a second user.

The first terminal unit 4, in the embodiment shown in FIG. 2, is a regular mobile phone of the first user. Using his mobile phone 4, the first user makes a telephone call to terminal unit 5 of the second user in order to discuss a business agreement.

The call is established in a usual manner, by establishing a radio link 14 between the mobile terminal unit 4 and radio communications means 12. The radio communications means 12 are connected to a base station 13 which is connected to the circuit switch telecommunications network 2. The circuit switched telecommunications network 2 consists of a plurality of nodes 7, 8, 9 and 10 interconnected with each other. Base station 13 is connected to network node 7. Terminal unit 5 is connected to network node 9. The voice call between terminal unit 4 and terminal unit 5 is established via radio communications means 12, base station 13, network node 7, network node 10 and network node 9. Instead of network node 10, network node 8 may be involved as well.

During the conversation, the first user, using terminal unit 4, proposes to record a part of the conversation, since the conversation parties (the first and the second user) are about to make a business decision. Since both parties wish to use the recording later on as evidence of the business decision, the recording should preferably be made by a trusted party and stored in a safe place in order to avoid tampering with the recording.

The recording is initiated by the first user using mobile terminal unit 4, which is a UMTS phone capable of making a parallel connection to the internet during the phone call. The internet is schematically indicated as a packet switched network 18 comprised of a plurality of network nodes 19, 20, 20, 21 and 22. A connection between the mobile terminal unit 4 and the Internet is set up via radio link 14, through radio communications unit 12 and base station 13 to node 19. From node 19, a connection is made via node 20 to a recording system 27 capable of recording ongoing telephone calls on the circuit switched network 2.

The first user provides instructions in the form of a control signal to the recording system 27 for initiating a recording of the ongoing telephone call. It is important that the recording system 27 is capable of identifying the ongoing telephone call in the circuit switched network 2. Therefore, control signals sent from mobile terminal unit 4 to recording system 27 via the packet switched connection comprise an identification of the ongoing telephone call on the circuit switched network 2. This identification may be implemented in a variety of ways. One way of identifying the ongoing telephone call on the circuit switched network 2, is by including the connected number of the mobile terminal unit 4 in the control signal, such that the recording system 27 is able to identify the ongoing telephone call based on a call detail record generated within the circuit switched telecommunications network 2. As will be appreciated identification of the ongoing telephone call may also be performed in a different way. Alternatively, the control signal may comprise a network call reference number, such as a global call reference number, party identification data of any other party, such as the connected number of terminal unit 5 of the second user, or any other suitable information.

The recording system 27 may not immediately start recording the telephone call. Optionally, and often required by privacy protection laws, the recording system 27 may request permission from the second user for recording the call. Therefore, the recording system 27 may send a signal or message to personal computer 25 which is connected to network node 21 on the packet switched network. Personal computer 25 is under the control of the second user, which receives the message and may reply to the message to give his consent for making the recording. Another option is that permission of the second user is requested after the recording has been made by recording system 27. In this latter case, the recording system 27 records the telephone call and asks permission to the second user sending a message or control signal via the packet switched network 18 to computer 25. The second user may receive this message for instance as an email on his computer, ans may reply to the email to give his consent. If the second user does not give permission for the recording, the recording which has been made of the telephone call is deleted by the recording system 27. It is noted that the recording system 27 may deny access to the recording as long as no permission has been received from the second user. Also, if the second user would not respond to the message from the recording system at all for giving his consent for the recording, the recording may optionally be timed out after expiry of a certain time period. In that case, after the time period is expired, the recording is also deleted by the recording system 27.

Assuming that the second user gives his consent for the recording prior to making the recording, the recording system identifies the ongoing telephone call and requests network node 10 to establish a (third party) connection with the virtual circuits of the ongoing call. Using the (third party) connection, the conversation is received by the recording system 27 without any of the conversation parties (first and second user) experiencing a disturbance in the conversation. If it is desired, the recording system 27 may optionally send an audible alarm at the start of the recording during the ongoing telephone call, such that both users are notified of the start of the recording. The recording may be ended by any of the first or second user providing further control signals via the packet switched network 18 to the recording system 27.

The recording may be stored in database 28 which is accessible either through the recording system 27, or separately via a connection 29 to network node 20. Any of the conversation parties may access the recording stored in the database 28. Access may for instance be controlled with usernames and passwords provided to each user.

The recording may also be encrypted in order to avoid an unauthorized party to intercept the data signal of the recording on the package switched network (11) and thereby in order to avoid “eavesdropping”. Also, the digital recording may comprise a verification code, which enables detection of any changes or amendments made to the recording after it was originally established.

Alternatively, instead of using a database 28, it is possible to encrypt the recording on the recording system 27 and send it to both conversation parties via the packet switched network 18.

With the method and system of the present invention, it is also possible to include additional data, such as a data file which is exchanged between the first user and a second user during the telephone call. Suppose, for instance, that the first user sends a spreadsheet of information using his mobile terminal unit 4 to the computer 25 of the second user. The recording system 27 may intercept the spreadsheet and store it together with the recording in database 28. One possible means of enabling the recording system 27 to intercept and store the spreadsheet is by digitally notifying the mobile terminal 4 that a recording is ongoing. Suitable means in the mobile terminal 4 (either software or hardware implemented) may send the spreadsheet to both computer 25 of the second user and to the recording system 27. Another option is to send the control signal to a recording system 27 which indicates that the spreadsheet is being sent from terminal unit 4 to computer 25. The recording system, upon receiving control signal, may either access the terminal unit 4 or the computer 25 to retrieve the spreadsheet. This may be established by including suitable identification data in the control signal provided to the recording system 27, such as an Internet protocol identification number (IP-number).

For the purpose of comprehensiveness, it is noted here that a numerous modifications and variations of the present invention are possible in the light of the above teachings. It is therefore understood that, within the scope of the appended claims, the invention may be practiced otherwise than as specifically described herein.

1. A method of recording at least a part of a conversation between a plurality of conversation parties, wherein said conversation is enabled by establishing a call between said parties within a circuit switched telecommunications network using a telecommunication service provided by a telecommunications provider, the method comprising the steps of:
recording said at least one part of said conversation in a data file using a recording system which is maintained by said telecommunications provider,
controlling said recording by control signals provided to said recording system through a packet switched telecommunications network by at least one of said conversation parties, wherein said control signals identify said call for associating said control signals with said conversation,
in addition to said call through said circuit switched telecommunications network, establishing a data stream between said conversation parties through said packet switched telecommunications network wherein said control signals further comprise data stream identification data for identifying said data stream, for including at least a part of said data stream in said data file.

2. The method according to claim 1, wherein at least one of said conversation parties connecting to said circuit switched telecommunications network and connecting to said packet switched telecommunications network.

3. The method according to claim 2, further comprising connecting to said circuit switched telecommunications network and connecting to said packet switched telecommunications network via a communication terminal.

4. The method according to claim 1, wherein said control signals are provided through a signalling channel associated with said call, and wherein said call is identified by said signalling channel.

5. The method according to claim 1, wherein said control signals comprise call identification data for identifying said call.

6. The method according to claim 5, wherein said call identification data comprises at least one element of a group comprising a network call reference number such as a global call reference number, party identification data for identifying at least one of said plurality of conversation parties, or call detail identification data for identifying a call detail record associated with said call.

7. The method according to claim 1, wherein said control signals comprise a request signal sent by at least one of said parties for commencement of said recording.

8. The method according to claim 7, wherein said control signals further comprise an approval signal sent by at least one of said parties for commencement of said recording.

9. The method according to claim 1, wherein said data file is encrypted using an encryption code.

10. The method according to claim 1, wherein said data file is made available to at least one of said conversation parties.

11. The method according to claim 1, wherein said data file is stored in a database, said database being operatively connected to said packet switched telecommunications network.

12. The method according to claim 10, wherein said database is accessible by said at least one of said parties for retrieving copies of said data file.

13. The method according to claim 10, wherein a copy of said data file is transmitted by said recording system to said at least one of said conversation parties.

14. The method according to claim 1, wherein additional data is included in said data file.

15. The method according to claim 14, wherein said additional data comprises an authentication code for certifying authenticity of said data file.

16. The method according to claim 14, wherein said additional data further comprises at least one element of a group comprising service data such as call data, a reference to a call detail record in a service database comprising call data, commencement time of said recording, termination time of said recording, duration of said recording, or party identification data for identifying at least one of said plurality of conversation parties.

17. The method according to claim 1, wherein access to said data file is controlled with user names and passwords of said conversation parties.

18. The method according to claim 1, wherein at least a part of said data stream transmitted between said conversation parties during said recording is included in said data file.

19. The method according to claim 1, wherein said at least one part of said data stream comprises at least one further data file, a user file comprising user data.

20. The method according to claim 1, wherein said call is selected from a group comprising a voice communication call, or a video conference.

21. A recording system arranged for recording at least a part of a conversation between a plurality of conversation parties, wherein said conversation is enabled by establishing a call between said parties within a circuit switched telecommunications network using a telecommunication service provided by a telecommunications provider, said recording system comprising:
means for receiving control signals from a packet switched telecommunications network
means for operatively connecting to said circuit switched telecommunications network for recording said at least one part of said conversation, and
means for creating a data file comprising recording data indicative of said at least one part of said conversation,
means for identifying said call by said control signals for associating said control signals with said conversation, wherein said recording system is further arranged for identifying, by data stream identification data included in said control signals, a data stream which is established between said conversation parties through said packet switched telecommunications network in addition to said call through said circuit switched telecommunications network, for including at least a part of said data stream in said data file.

22. The recording system according to claim 21, wherein said means for receiving said control signals are arranged for receiving said control signals from a signalling channel associated with said call, and wherein said means for identifying said call are arranged for identifying said call from said signalling channel.

23. The recording system according to claim 21, wherein said means for identifying said call are arranged for identifying said call from a call identification signal comprised in said control signals.

24. The recording system according to claim 21, further comprising means for storing said data file in a database operatively connected to said packet switched telecommunications network.

25. The recording system according to claim 21, further comprising means for including an authentication code in said data file.

26. The recording system according to claim 21, further comprising means for encrypting said data file.

27. An arrangement comprising:
a circuit switched telecommunications network for enabling a conversation between a plurality of conversation parties by establishing a call between said parties within said circuit switched telecommunications network using a telecommunication service provided by a telecommunications provider,
a packet switched telecommunications network for remotely providing control signals to said recording system for controlling said recording, and
a recording system for recording at least a part of a conversation between a plurality of conversation parties, said recording system comprising:
means for receiving control signals from a packet switched telecommunications network;
means for operatively connecting to said circuit switched telecommunications network for recording said at least one part of said conversation, means for creating a data file comprising recording data indicative of said at least one part of said conversation, and
means for identifying said call by said control signals for associating said control signals with said conversation, wherein said arrangement is further arranged for identifying, by data stream identification data included in said control signals, a data stream which is established between said conversation parties through said packet switched telecommunications network in addition to said call through said circuit switched telecommunications network, for including at least a part of said data stream in said data file.
